(19) United States
(12) Patent Application Publication
(10) Pub. No.: US 2006/0126964 A1
(43) Pub. Date: Jun. 15, 2006

(54) Method of and system for image processing and computer program

(75) Inventor: Tao Chen, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/298,700

(22) Filed: Dec. 12, 2005

(30) Foreign Application Priority Data
Dec. 10, 2004 (JP) 358012/2004

(51) Int. Cl. G06K 9/36; G06K 9/46

(52) U.S. Cl. 382/286; 382/190

(57) ABSTRACT

A skin-colored area is detected in a face. A lateral width of the detected skin-colored area is detected in each of the positions along a direction from the vertex to the chin of the face, and the lateral width in a predetermined position in a range from a first position to a second position is determined as the lateral width of the face. The first position is a position in which the lateral width uncontinuously increases, and the second position is a position which is nearer to the chin than the first position and remoter from the chin by one position than the position in which the lateral width uncontinuously decreases.

### BACKGROUND OF THE INVENTION

1. Field of the Invention

This invention relates to a method of and system for image processing for detecting the widths of faces in photographs of face, and more particularly, to a computer program for the image processing.

2. Description of the Related Art

For example, application of a passport or a license or making own personal history often requires a photograph of his or her face output in a predetermined standard (will be referred to as “a certification photograph”, hereinbelow.) The output standard of certification photographs generally defines the length of the face (or of a part of the face) together with the length of the finished photograph in the vertical direction whereas in the lateral direction, the output standard of certification photograph generally defines only the length (width) of the face and does not define the width of the face.

In order to obtain such a certification photograph, there have been proposed various methods. For example, there has been disclosed in Japanese Unexamined Patent Publication No. 11(1999)-341272 a method where when, with an image of a face used for a certification photograph displayed by a display device such as a monitor, positions of the vertex and the tip of the chin (will be referred to as “the position of the chin”, hereinbelow.) of the displayed face are designated, a computer obtains the position and the size of the face on the basis of the designated two positions, and at the same time, the computer enlarges or contracts the image of the face according to the output standard of certification photographs and trims the enlarged or contracted image so that the face is positioned in a predetermined position in the certification photograph. With this method, the user can request a certification photograph of a DPE shop or the like and at the same time, the user can request a DPE shop or the like to make a certification photograph from a photograph which he or she favors.

Further, as disclosed in Japanese Unexamined Patent Publication No. 2004-005384 and U.S. Patent Application Publication No. 20050013599, there have been proposed methods where instead of operator's manual designation, parts such as the face and the mouth are detected from the image of the face, the positions of the vertex and the chin are estimated on the basis of the detected positions of the parts and the trimming is carried out on the basis of the estimated positions of the vertex and the chin to form a certification photograph.

However, recently, on the basis of increasing requirements for the security, there is a tendency that the standard of certification photographs defines the width of the face together with the length of the same, and accordingly, it becomes necessary to grasp the width of the face in photographs of face and trims the photographs of face.

In fields other than the certification photograph, the width of the face in photographs of face is sometimes necessary. For example, when graduation albums are to be prepared, it is desired that the face in the photographs of face in each finished album are of substantially the same size. In order to unify the sizes of the face, it is necessary to obtain not only the length of the face but also the width of the face and to make the faces to be substantially the same in area.

In order to make a photograph in which the width of the face in the finished photograph meets the standard, it is thus necessary to grasp the width of the face in the original photographic images of the face. However, there has been conventionally no way to detect the width of the face in the photographic images of the face.

### SUMMARY OF THE INVENTION

In view of the foregoing observations and description, the primary object of the present invention is to provide a method of and system for image processing for detecting the widths of faces in photographs of face for trimming which meets the strict standard of the certification photographs or for image processing to unify the size of the faces in a plurality of photographic images and a computer program for the image processing.

In accordance with the present invention, there is provided an image processing method for detecting the lateral widths of faces in photographs of face comprising the steps of

detecting a skin-colored area in a face,

obtaining a lateral width of the detected skin-colored area in each of the positions along a direction from the vertex to the chin of the face, and

determining the lateral width in a predetermined position in a range from a first position to a second position as the lateral width of the face, the first position being a position in which the lateral width uncontinuously increases, and the second position being a position which is nearer to the chin than the first position and remoter from the chin by one position than the position in which the lateral width uncontinuously decreases.

In the image processing method of the present invention, it is preferred that the largest lateral width in the range from the first position to the second position be determined as the lateral width of the face.

In the image processing method of the present invention, the larger of the lateral width in the first position and that in the second position may be determined as the lateral width of the face.

In the image processing method of the present invention, it is preferred that the skin-colored area in the face be detected as an area formed by pixels detected by setting an area which is estimated to be of a skin-color in the face as a reference area, and detecting pixels which are of a color approximating the color of the reference area from the face.

It is preferred that the reference area be an area between the eyes and the tip of the nose in the face.

In accordance with the present invention, there is further provided an image processing system for detecting the lateral widths of faces in photographs of face comprising

a skin-colored area detecting means for detecting a skin-colored area in a face;

a width obtaining means for obtaining a lateral width of the detected skin-colored area in each of the positions along a direction from the vertex to the chin of the face, and

a face width determining means for determining the lateral width in a predetermined position in a range from a first position to a second position as the lateral width of the face, the first position being a position in which the lateral width uncontinuously increases, and the second position being a position which is nearer to the chin than the first position and remoter from the chin by one position than the position in which the lateral width uncontinuously decreases.

In the image processing system of the present invention, it is preferred that the face width determining means determines the largest lateral width in the range from the first position to the second position as the lateral width of the face.

In the image processing system of the present invention, the face width determining means may determine the larger of the lateral width in the first position and that in the second position as the lateral width of the face.

In the image processing system of the present invention, it is preferred that the skin-colored area detecting means comprises a reference area setting means which sets an area which is estimated to be of a skin-color in the face as a reference area, and a skin-colored pixel detecting means which detects pixels which are of a color approximating the color of the reference area from the face and detects as the skin-colored area an area formed by the detected pixels.

It is preferred that the reference area setting means sets an area between the eyes and the tip of the nose in the face as the reference area.

Further, a computer program for causing a computer to execute the image processing method of the present invention may be recorded in computer readable media. A skilled artisan would know that the computer readable media are not limited to any specific type of storage devices and include any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

In accordance with the image processing method and system of the present invention, a skin-colored area is detected in an image of the face on the basis of the fact that the lateral width of the human face abruptly increases at the upper root of the ears and abruptly decreases at the lower root of the ears, and the position where the lateral width of the skin-colored area uncontinuously increases is obtained as a first position (i.e., the upper root of the ears) while the position which is nearer to the chin than the first position and remoter from the chin than the other positions in which the lateral width uncontinuously decreases is obtained as a second position (i.e., the lower root of the ears). And on the basis of the fact that the lateral width of the human face hardly changes between the upper root of the ears and the lower root of the ears, the lateral width in a predetermined position in the range is obtained as the lateral width of the face. By this, the lateral width of faces can be surely obtained.

Though, the lateral width in any position in the range may be taken as the lateral width of the face, the lateral width of the face can be more accurately obtained if the largest lateral width in the range is determined as the lateral width of the face.

Further, since when statistically viewed, the human face is often maximized in its lateral width in the position of the upper root of the ears or in the position of the lower root of the ears, the lateral width of faces can be rapidly obtained when the larger of the lateral width in the position of the upper root of the ears and that in the position of the lower root of the ears is determined as,the lateral width of the face.

In this invention, it is necessary to detect a skin-colored area in a face in order to detect the lateral width of the face in each of the positions. However the color of the human skin largely changes depending on the race, the degree of the sunburn, or the like. Accordingly, when the skin-colored area in the face is detected as an area formed by the pixels detected by setting an area which is estimated to be of a skin-color in the face as a reference area, and detecting pixels which are of a color approximating the color of the reference area from the face, the skin color can be certainly detected without being affected by the difference among the individuals, which leads to an accurate detection of the lateral width of the face.

### BRIEF DESCRIPTION OF THE DRAWINGS

FIG. 1 is a block diagram showing an image processing system in accordance with an embodiment of the present invention,

FIG. 2 is a block diagram showing the face detecting portion,

FIG. 3 is a block diagram showing the eye detecting portion,

FIGS. 4A and 4B are views for illustrating the position of the center of the eye,

FIG. 5A is a view showing the horizontal edge detecting filter,

FIG. 5B is a view showing the vertical edge detecting filter,

FIG. 6 is a view for illustrating calculation of a gradient vector,

FIG. 7A is a view showing a face of a person,

FIG. 7B is a view showing gradient vectors near the eyes and the mouth of the face of the person shown in FIG. 7A,

FIG. 8A is a view showing the histogram of the size of the gradient vector before normalization,

FIG. 8B is a view showing the histogram of the size of the gradient vector after normalization,

FIG. 8C is a view showing the histogram of the size of the five-valued gradient vector,

FIG. 8D is a view showing the histogram of the size of the five-valued gradient vector after normalization,

FIG. 9 are views showing the sample images which have been known that they are the images of face and are used in learning the first reference data,

FIG. 10 are views showing the sample images which have been known that they are the images of face and are used in learning the second reference data,

FIGS. 11A to 11C are views for illustrating rotation of faces,

FIG. 12 is a flowchart showing learning of the reference data,

FIG. 13 is a view showing derivation of the distinguishers,

FIG. 14 is a view showing the stepwise deformation of the images to be distinguished,

FIG. 15 is a block diagram showing setting of the reference area,

FIG. 16 is a block diagram showing the structure of the skin-colored area detecting portion,

FIG. 17 is a block diagram for illustrating the face area mask generating portion,

FIGS. 18A to 18C are views for illustrating the processing in the face area mask generating portion,

FIG. 19 is a block diagram showing the structure of the face lateral width obtaining portion, and

FIG. 20 is a flowchart showing the processing in the image processing system shown in FIG. 1.

### DESCRIPTION OF THE PREFERRED EMBODIMENT

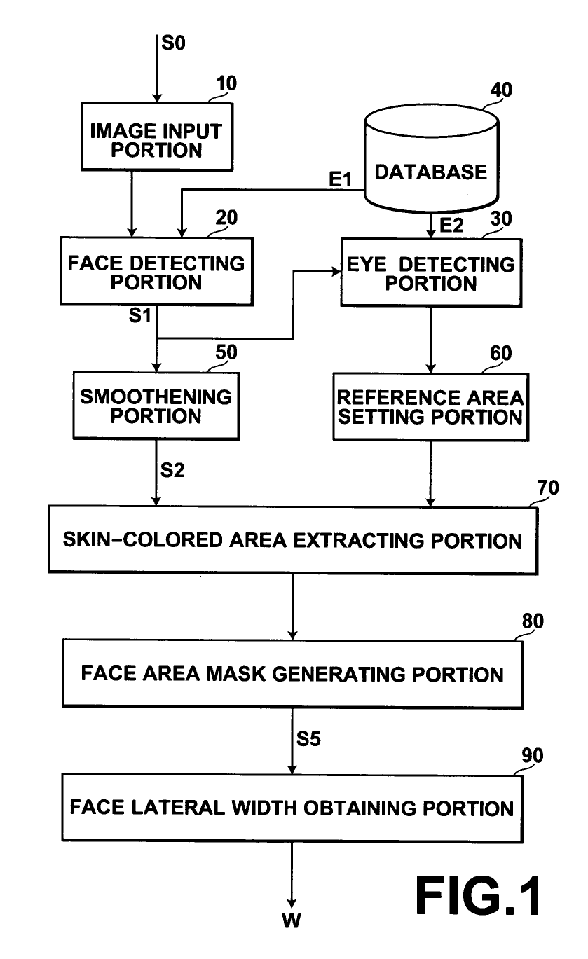

FIG. 1 is a block diagram showing an image processing system in accordance with an embodiment of the present invention. In the image processing system of this embodiment, the lateral width of the face in photographic images of the face S0 is detected from the photographic images S0, and the processing of detecting the lateral width of the face is executed by causing a computer (e.g., a personal computer) to perform the processing program read in an auxiliary storage means. The processing program is stored in a recording medium such as a CD-ROM or distributed by way of a network such as the Internet, and installed in the computer.

As shown in FIG. 1, the image processing system of this embodiment comprises an image input portion 10 through which photographic images S0 are input, a face detecting portion 20 which detects the approximate position and size of the face in each of the images S0 from the image input portion 10 and obtains the image of the face S1 (will be referred to as “the face image S1”, hereinbelow), an eye detecting portion 30 which detects the positions of the eyes in the face image S1, a database 40 which stores reference data E1 and reference data E2 to be described later which are used in the face detecting portion 20 and the eye detecting portion 30, a smoothening portion 50 which carries out smoothening processing on the face image S1 obtained by the face detecting portion 20 to obtain a smoothened face image S2, a reference area setting portion 60 which sets as a reference area an area which is certainly of a skin-color on the basis of result of detection by the eye detecting portion 30, a skin-colored area extracting portion 70 which extracts a skin-colored area from the smoothened face image S2 on the basis of the color of the reference area set by the reference area setting portion 60, a face area mask generating portion 80 which carries out processing such as noise removing processing and generates a face area mask image S5 from the image of the skin-colored area extracted by the skin-colored area extracting portion 70, and a face lateral width obtaining portion 90 which obtains the lateral width W of the face by the use of the face area mask image S5.

The image input portion 10 is for inputting the photographic images S0 to be processed by the image processing system of this embodiment and may comprise, for instance, a receiving portion which receives the photographic images S0 sent by way of a network, a read-out portion which reads out the photographic images S0 from a recording medium such as a CD-ROM, a scanner which photoelectrically reads out an image printed on a printing medium such as a paper and a printing paper, and the like.

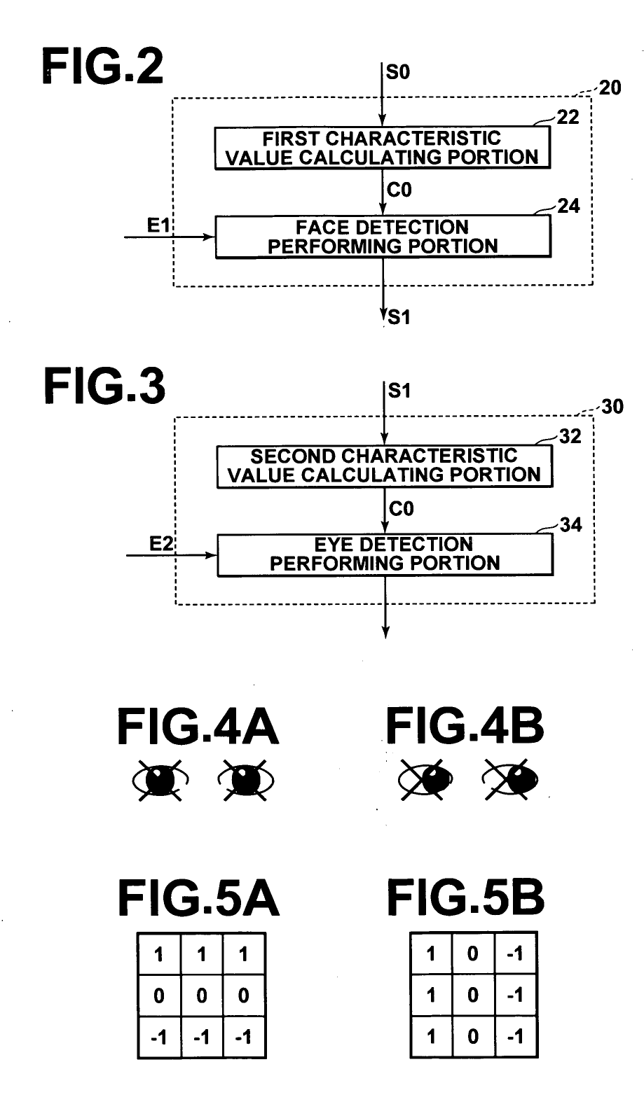

FIG. 2 is a block diagram showing the face detecting portion 20, of the image processing system shown in FIG. 1. As shown in FIG. 2, the face detecting portion 20 is for detecting the approximate position and size of the face in each of the photographic images S0 and extracts an image of the area represented by the position and size from the photographic image S0 to obtain the face image S1 and comprises a first characteristic value calculating portion 22 which calculates a characteristic value CO from the photographic image S0 and a face detection performing portion 24 which performs face detection by the use of the characteristic value C0 and the reference data E1 stored in the database 40. The reference data E1 stored in the database 40 and the face detecting portion 20 will be described in detail, hereinbelow.

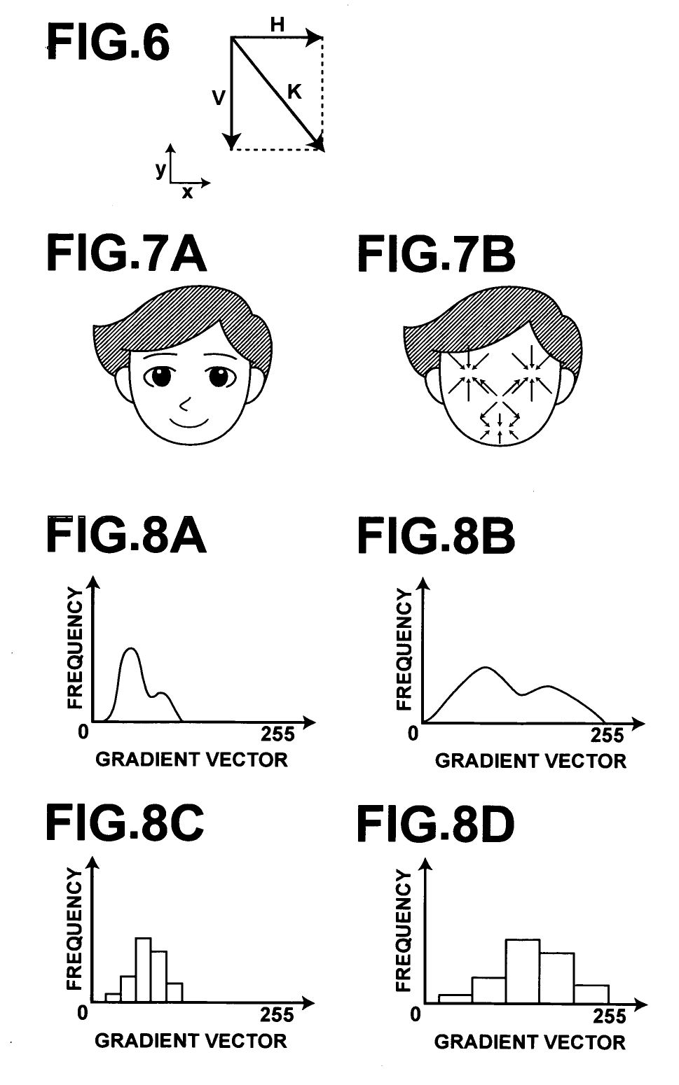

The first characteristic value calculating portion 22 of the face detecting portion 20 calculates the characteristic value C0 for use in distinguishment of a face from the photographic images S0. For example, the first characteristic value calculating portion 22 calculates gradient vectors as the characteristic value C0. Calculation of the gradient vectors will be described, hereinbelow. The first characteristic value calculating portion 22 first detects horizontal edges by carrying out on the images S0 filtering by the use of a horizontal edge detecting filter shown in FIG. 5A. Then the first characteristic value calculating portion 22 detects vertical edges by carrying out on the images S0 filtering by the use of a vertical edge detecting filter shown in FIG. 5B. The first characteristic value calculating portion 22 further calculates a gradient vector K for each pixel as shown in FIG. 6 on the basis of the size H of the horizontal edge and the size V of the vertical edge of each pixel on the images S0.

The gradient vectors K thus calculated, in the case of a face of a person as shown in FIG. 7A, are directed toward the center of an eye or a mouth in a dark part such as eyes or a mouth and are directed outward from the position of a nose in a light part such as a nose. Since the eye is larger than the mouth in change of density, the gradient vectors K are larger in the eye than in the mouth.

The direction and the size of the gradient vector are taken as the characteristic value C0, The direction of the gradient vector K is of a value of 0 to 359° with a predetermined direction (e.g., x direction in FIG. 6) taken as a reference.

Then the size of the gradient vector K is normalized. The normalization is effected by obtaining a histogram of the sizes of the gradient vectors K of all the pixels in the images S0, smoothening the histogram so that the distribution of the sizes of the gradient vectors K are uniformed over the range of values which the pixels in the images S0 can take (0 to 255 in the case of 8 bit signals), and correcting the sizes of the gradient vectors K on the basis of the smoothening. For example, when the sizes of the gradient vectors K is small and the histogram thereof leans toward the smaller side as shown in FIG. 8A, the sizes of the gradient vectors K are normalized so that the sizes of the gradient vectors K are distributed over the entire range of 0 to 255 and the histogram is as shown in FIG. 8B. In order to reduce the amount of calculation, it is preferred that the distribution range of the gradient vectors in the histogram be divided into, for instance, five, as shown in FIG. 8C, and the gradient vectors be normalized so that the sizes of the gradient vectors K are distributed over the entire range of 0 to 255 in all the frequency distributions divided into five as shown in FIG. 8D.

The reference data E1 stored in the database 40 is obtained by defining the distinguishing conditions to a combination of the characteristic values C0 in each of the pixels forming each pixel group for each of a plurality of pixel groups comprising a combination of a plurality of pixels selected from sample images to be described later.

The distinguishing conditions to a combination of the characteristic values C0 in each of the pixels forming each pixel group in the reference data E1 have been determined in advance by learning a plurality of sample images which have been known that they are the images of face and a plurality of sample images which have been known that they are not the images of face.

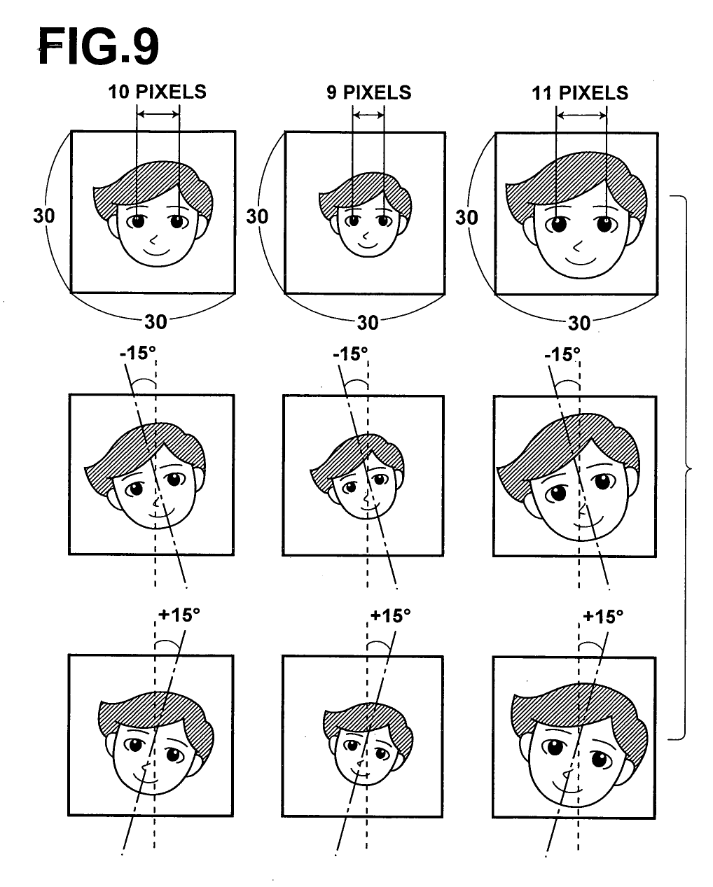

When the reference data E1 is generated in this embodiment, as the sample images which have been known that they are the images of face, sample images each of which has a size of 30×30 pixels, in which the center-to-center distances between the eyes are 10 pixels, 9 pixels, and 11 pixels and which are obtained by rotating the image of the face perpendicular to the straight line joining the centers of the eyes stepwise by 3° within ±15° in the plane (i.e., −15°, −12°, −9°, −6°, −3°, 0°, 3°, 6°, 9°, 12°, 15°) as shown in FIG. 9 are employed for each face. That is, 33 (3×11) sample images are prepared for each face. In FIG. 9, only the sample images obtained by rotating the image of the face perpendicular to the straight line joining the centers of the eyes by −15°, 0° and +15° in the plane are shown. The center of rotation is the intersection of the diagonal lines of the sample image. The centers of the eyes are the same in the case of the sample images in which the center-to-center distances between the eyes are 10 pixels. Coordinates of the centers of the eyes are taken as (x1, y1) and (x2, Y2) in the coordinate system having an origin on the upper left corner of the sample image. The positions of the eyes in the vertical direction (i.e., y1 and y2) are the same in all the sample images.

As the sample images which have been known that they are not the images of face, arbitrary sample images each of which has a size of 30×30 pixels are employed.

In the case where only the sample images which have been known that they are the images of face, are 10 pixels in the center-to-center distances between the eyes and 0° in the rotational angle (that is, the images where the face is vertical) are learned, only the images of faces which are 10 pixels in the center-to-center distances between the eyes and are not rotated by any angle will be distinguished as a face image when the reference data E1 is referred to. The sizes of the face images which can be included in the photographic images S0 are not constant. Accordingly, the photographic images S0 are enlarged or contracted to distinguish a position of face which conforms in size to the sample images when determining whether a face image is included in the photographic images S0 as will be described later. However, in order to enlarge or contract an image so that the center-to-center distances between the eyes thereof is accurately 10 pixels, it is necessary to effect the distinguishment while the photographic images S0 is enlarged or contracted stepwise, for instance, by 1.1, which results in a vast amount of calculation.

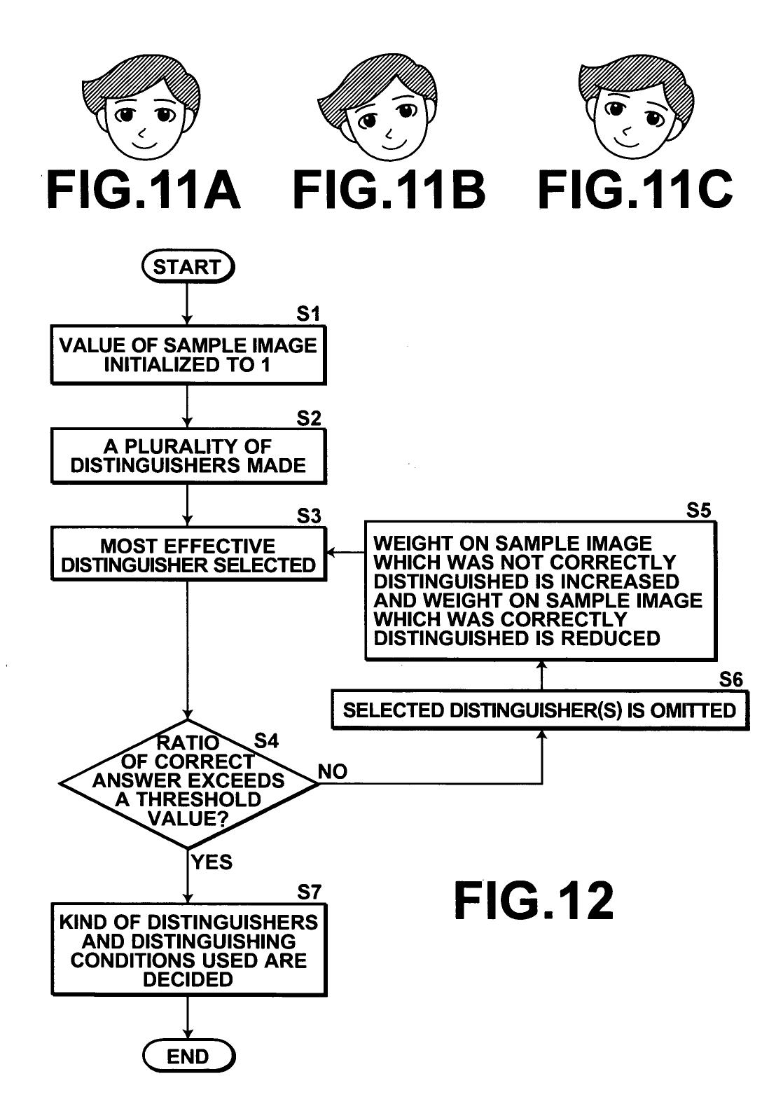

The face images which can be included in the photographic images S0 can include not only the images where the face rotational angle is 0° as shown in FIG. 11A but also the images where the face is rotated as shown in FIGS. 11B and 11C. However, when the sample images which are 10 pixels in the center-to-center distances between the eyes and 0° in the rotational angle are only learned, the faces rotated as shown in FIG. 11B or 11C cannot be distinguished as a face.

Accordingly, in this embodiment, the sample images in which the center-to-center distances between the eyes are 9 pixels, 10 pixels, and 11 pixels and which are obtained by rotating the image of the face perpendicular to the straight line joining the centers of the eyes stepwise by 3° within +15° in the plane as shown in FIG. 9 are employed as the sample images which have been known that they are the images of face so that the learning of reference data E1 has a tolerance. By this, when the face detection performing portion 24 to be described later effects the distinguishment, the photographic images S0 have only to be enlarged or contracted stepwise by 11/9 and accordingly the calculating time can be shortened as compared with when the photographic images S0 have to be enlarged or contracted stepwise by 1.1. Further, the faces which have been rotated as shown in FIG. 11B or 11C can be distinguished.

An example of learning the sample image group will be described with reference to the flow chart shown in FIG. 12, hereinbelow.

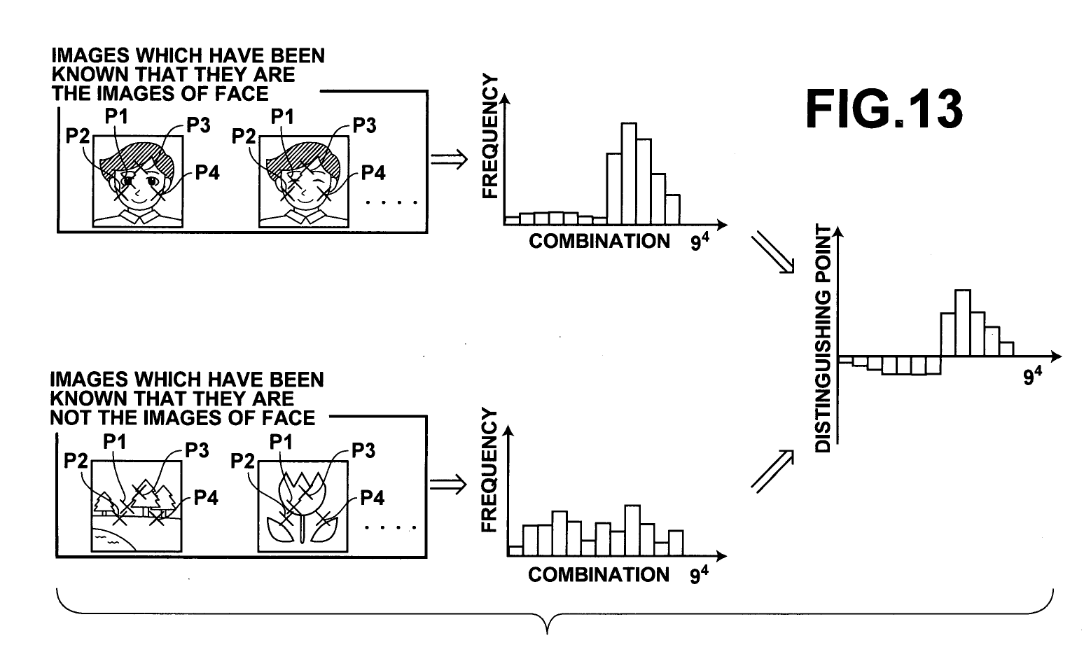

In FIG. 13, the pixels forming the distinguisher are a pixel P1 on the center of the right eye, a pixel P2 on the right cheek, a pixel P3 on the forehead and a pixel P4 on the left cheek of the sample images which have been known that they are the images of face as shown on the left side of FIG. 13. Then the combination of the characteristic values C0 on all the pixels P1 to P4 for all the sample images which have been known that they are the images of face, and the histogram thereof is made. Though the characteristic value represents the direction and size of the gradient vector K, since the direction of the gradient vector K is written in 360 (0 to 359) ways and the size of the gradient vector K is written in 256 (0 to 255) ways, the combination can be written in (360×256) ways per one pixel when they are used as they are. That is, the combination for 4 pixels can be written in (360×256)⁴ ways when they are used as they are and a vast number of samples, a long time and a vast number of memories are required. Accordingly, in this embodiment, the direction 0 to 359 of the gradient vector K is four-valued into a rightward direction (0 to 44 and 315 to 359, value 0), an upward direction (45 to 134, value 1), a leftward direction (135 to 224, value 2) and a downward direction (225 to 314, value 3) and the size of the gradient vector K is three-valued (values 0 to 2). Then the value of the combination is calculated according to the following formulae.

the value of the combination=0 (in the case where the size of the gradient vector=0)
the value of the combination=((the direction of the gradient vector+1)×the size of the gradient vector (in the case where the size of the gradient vector>0))

Since the number of combinations becomes 9⁴ with this arrangement, the number of pieces of data on the characteristic value can be reduced.

Similarly, a histogram is made for the sample images which have been known that they are not the images of face. In the case of the sample images which have been known that they are not the images of face, pixels corresponding to the positions of the pixels P1 to P4 on the sample images which have been known that they are the images of face are used. The histogram representing the logarithmic values of the ratio of the frequencies shown by the two histograms is the histogram which is shown on the rightmost side of FIG. 13 and used as the distinguisher. The value of the ordinate shown by each of the histograms of the distinguisher will be referred to as “the distinguishing point”, hereinbelow. In accordance with the distinguisher, there is a strong probability that the images exhibiting a distribution of the characteristic values corresponding to a positive distinguishing point are images of face, and as the absolute values of the distinguishing point increases, the probability becomes stronger. Conversely, there is a strong probability that the images exhibiting a distribution of the characteristic values corresponding to a negative distinguishing point are not images of face, and as the absolute values of the distinguishing point increases, the probability becomes stronger. In step S2, on the basis of the combination of the characteristic values C0 on all the pixels forming a plurality of pixel groups which may be employed in the distinguishment, a plurality of the distinguishers in the form of a histogram are made.

Then, out of the distinguishers made in step S2, a distinguisher which is the most effective to distinguish whether the image is of a face is selected. This selection is effected taking into account the weights of the sample images. In this example, the weighted ratios of the correct answers of the distinguishers are compared, and the distinguisher exhibiting the highest weighted ratio of the correct answers is selected. (step S3) That is, since initially the sample images are equally weighted by 1, the distinguisher having the most sample images which are correctly distinguished as the image of face by the distinguisher is selected as the most effective distinguisher in the initial step S3. Whereas, in second step S3 after the weight of each sample image is updated in step S5 as will be described later, sample images whose weight is 1, sample images whose weight is larger than 1 and sample images whose weight is smaller than 1 mingle with each other and the sample image whose weight is larger than 1 is more counted than the sample whose weight is 1 in the evaluation of the ratio of the correct answers. By this, in steps S3 after the second step S3, a more importance is put on the sample images weighted more than the sample images weighted less.

Then whether the ratio of the correct answers of the combination of the distinguishers up to that time, that is, the ratio at which the result of distinguishment whether the sample images are images of face by the use of the distinguishers combined up to that time conforms to the answer whether the sample images are actually images of face, exceeds a predetermined threshold value is checked. (step S4) The sample images used here in the evaluation of the ratio of the correct answers may be the sample images with a current weight or the equally-weighted sample images. When the ratio exceeds the predetermined threshold value, the learning is ended since whether the images are of a face can be distinguished at a sufficiently high probability by the use of the distinguishers selected up to that time. When the ratio does not exceed the predetermined threshold value, the processing proceeds to step S6 in order to select one or more additional distinguisher to be combined with the distinguishers selected up to that time.

In step S6, in order for the distinguisher (s) selected in the preceding step S3 not to be selected again, the once-selected distinguisher(s) is omitted.

Then, the weight on the sample image which was not correctly distinguished whether it is an image of face in the preceding step S3 is increased and the weight on the sample image which was correctly distinguished whether it is an image of face in the preceding step S3 is reduced. (step S5) The reason why the weights are increased or reduced is that an importance is put on an image which was not correctly distinguished by the distinguishers which have been already selected so that a distinguisher which can correctly distinguish the image whether it is of a face, thereby enhancing the effect of the combination of the distinguishers.

Thereafter, the processing returns to step S3 where the next most effective distinguishers are selected on the basis of the weighted ratio of the correct answers as will be described above.

After distinguishers corresponding to the combination of characteristic values Co in each of the pixels forming a particular pixel group is selected as distinguishers which are suitable for distinguishing whether the image includes a face by repeating steps S3, to S6, the kind of the distinguishers and the distinguishing conditions used in distinguishment of whether the image includes a face are decided. (step S7) Then the leaning of the reference data E1 is ended.

When the learning procedure described above is employed, the distinguisher need not be limited to those in the form of a histogram but may be any so long as it provides data on the basis of which whether the image is of a face can be distinguished by the use of the combination of characteristic values Co in each of the pixels forming a particular pixel group, e.g., the distinguisher may be two-valued data, a threshold value or a function. Further, just the same, in the form of a histogram, a histogram representing the distribution of the difference between the two histograms shown at the middle of FIG. 13 may be employed.

Further, the learning procedure need not be limited to that described above but other machine learning procedures such as neural network may be employed.

The face detection performing portion 24 refers to the distinguishing conditions which the reference data E1 has learned for all the combinations of characteristic values Co in each of the pixels forming a plurality of pixel groups to obtain the distinguishing point of the combination of characteristic values Co in each of the pixels forming pixel groups, and detects a face on the basis of all the distinguishing points. At this time, the direction and the size of the gradient vector which are the characteristic value Co are four-valued and three-valued, respectively. In this embodiment, all the distinguishment points are summed and a face is detected on the basis of whether the sum is positive or negative, and of the magnitude of the sum. For example, when the sum of the distinguishment points is positive, it is determined that the image is of a face, whereas when the sum of the distinguishment points is negative, it is determined that the image is not of a face.

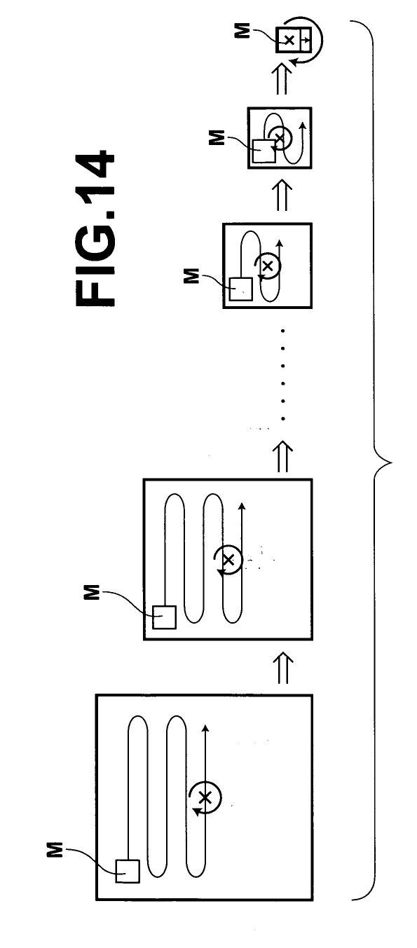

The photographic images S0 can differ from the sample images of 30 pixels×30 pixels and can be of various sizes. Further, when the image includes a face, the face sometimes rotated by an angle other than 0°. Accordingly, the face detection performing portion 24, while enlarging or contracting the photographic image S0 until the vertical side or the horizontal side thereof becomes 30 pixels and stepwise rotating it through 360° in the plane (FIG. 14 shows a state where the image is contracted), sets a mask M of 30×30 pixels on the photographic image enlarged or contracted in each step, and distinguishes whether the image in the mask M is of a face (that is, whether the sum of the distinguishing points is positive or negative) while moving the mask M one pixel by one pixel on the enlarged or contracted photographic image S0 as shown in FIG. 14. This distinguishment is carried out on the photographic image C0 in all the steps of enlargement/contraction and rotation, and the area of 30×30 pixels corresponding to the position of the mask M at the detection is detected as a face area from the photographic image S0 of the size and the rotational angle in the step in which the sum of the distinguishing points is positive and the largest, and at the same time, the image in this area is extracted as a face image S1 from the photographic image S0.

Further, since the center-to-center distances between the eyes are 9, 10, or 11 pixels in the sample images employed when the sample images are learned to generate the reference data E1, the ratio of enlargement to enlarge or contract the photographic image S0 may be 11/9. Since in the sample images used in learning upon generation of the reference data El, faces are rotated within ±15° in the plane, the photographic images S0 have only to be rotated through 360° 30° by 30°.

The first characteristic value calculating portion 22 calculates the characteristic value on each stage of deformation of the photographic images S0, e.g., enlargement/contraction or the rotation of the photographic images S0.

The face detecting portion 20 thus detects approximate positions and the sizes of the faces from the photographic images S0, and obtains the face images S1.

The eye detecting portion 30 detects the positions of the eyes from the face images S1 obtained by the face detecting portion 20 and FIG. 3 is block diagram showing the arrangement of the eye detecting portion 30. As shown in FIG. 3, the eye detecting portion 30 comprises a second characteristic value calculating portion 32 which calculates a characteristic value C0 from the face images S1 and an eye detection performing portion 34 which performs the eye detection on the basis of the characteristic value C0 and the reference data E2 stored in the database 40.

The position of the eye to be distinguished by the eye detection performing portion 34 is the center between the outside corner of the eye and the inner side of the eye indicated at x in FIG. 4A or 4B. In the case of an eye looking right ahead, it is the same as the center of the pupil as shown in FIG. 4A whereas in the case of an eye looking rightward, it is in a position deviated from the center of the pupil or on the white of the eye.

Since being the same as the first characteristic value calculating portion 22 in the face detecting portion 20 shown in FIG. 2 except that it calculates the characteristic value C0 from the face images S1 instead of the photographic image S0, the second characteristic value calculating portion 32 will not be described in detail.

The second reference data E2 stored in the database 40 defines the distinguishing conditions, for each of a plurality of pixel groups comprising a combination of a plurality of pixels selected from the sample images to be described later, for distinguishing the combination of the characteristic value C0 of each of the pixels forming each of the pixel groups as the first reference data E1.

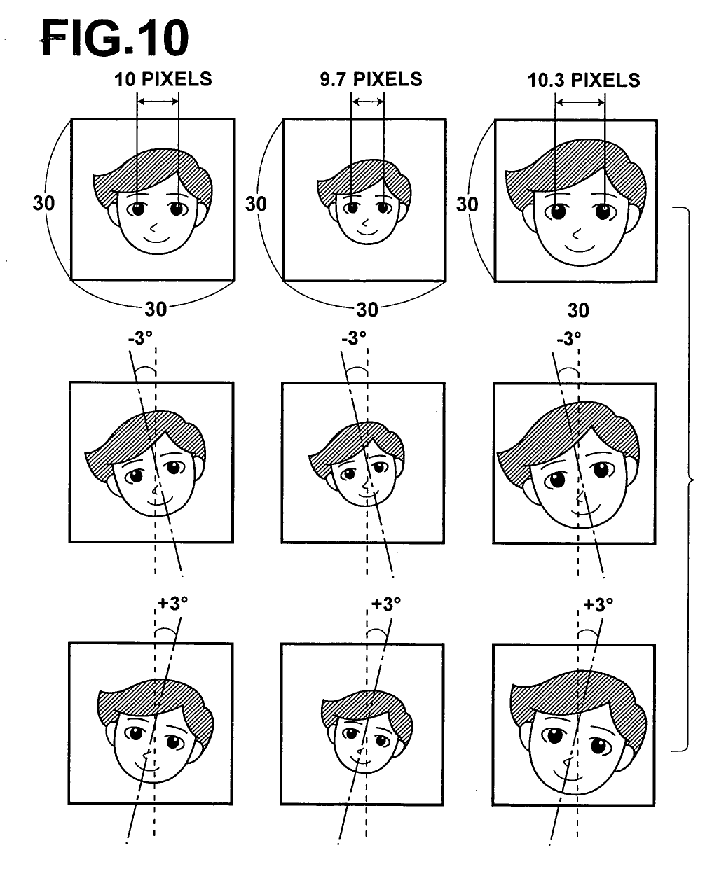

For learning of the second reference data E2, there are used sample images which are 9.7 pixels, 10 pixels and 10.3 pixels in the center-to-center distances between the eyes and are obtained by rotating the image of the face stepwise by 1° within ±3° in the plane as shown in FIG. 10. Accordingly, the second reference data E2 is narrow in the tolerance of learning as compared with the first reference data E1, and in accordance with the second reference data E2, the positions of the eyes can be detected more accurately. Further, since being equal to learning of the first reference data E1 except the sample pixel groups employed, the second reference data E2 will not be described here.

The eye detection performing portion 34 obtains, referring to the distinguishing conditions which the second reference data E2 has learned on all the combinations of the characteristic values C0 in the, the distinguishing point on the combination of each of the pixels forming each of the pixel groups and distinguishes the position of the eyes included in the face on the basis of all the distinguishing points. At this time, the direction and the size of the gradient vector K which are the characteristic values C0 are respectively four-valued and three-valued.

The eye detection performing portion 34, while stepwise enlarging or contracting the face image S1 obtained by the face detecting portion 20 and stepwise rotating it through 360° in the plane, sets a mask M of 30×30 pixels on the face image enlarged or contracted in each step, and detects the position of the eyes while moving the mask M one pixel by one pixel on the enlarged or contracted face image.

Further, since the center-to-center distances between the eyes are 9.07, 10, or 10.3 pixels in the sample images employed when the sample images are learned to generate the second reference data E2, the ratio of enlargement to enlarge or contract the photographic image S0 maybe 10.3/9.7. Since in the sample images used in learning upon generation of the reference data E1, faces are rotated within ±3° in the plane, the face images S1 have only to be rotated through 360° 6° by 6°.

The second characteristic value calculating portion 32 calculates the characteristic value C0 on each stage of deformation, e.g., enlargement/contraction or the rotation of the face images S1.

Then, in this embodiment, all the distinguishing points are summed on all the stages of deformation of the face images S, and in the image in the 30×30 pixel mask M on the stage of deformation where the sum is the largest, a coordinate system having its origin on the upper left corner is set. Then positions corresponding to coordinates (x1, y1) and (x2, y2) of the positions of eyes of the sample image are obtained and positions corresponding to the positions in the face image S1 before deformation are detected as the positions of the eyes.

The eye detecting portion 30 thus detects positions of the eyes from the face image S1 obtained by the face detecting portion 20.

The smoothening portion 50 carries out smoothening processing on the face image S1 in order to facilitate a later extraction of a skin-colored area and in this particular embodiment, obtains a smoothened image S2 by applying a Gaussian filter as the smoothening filter to the face image S1. The smoothening portion 50 carries out smoothening processing on the face image S1 by the channels R, G, B.

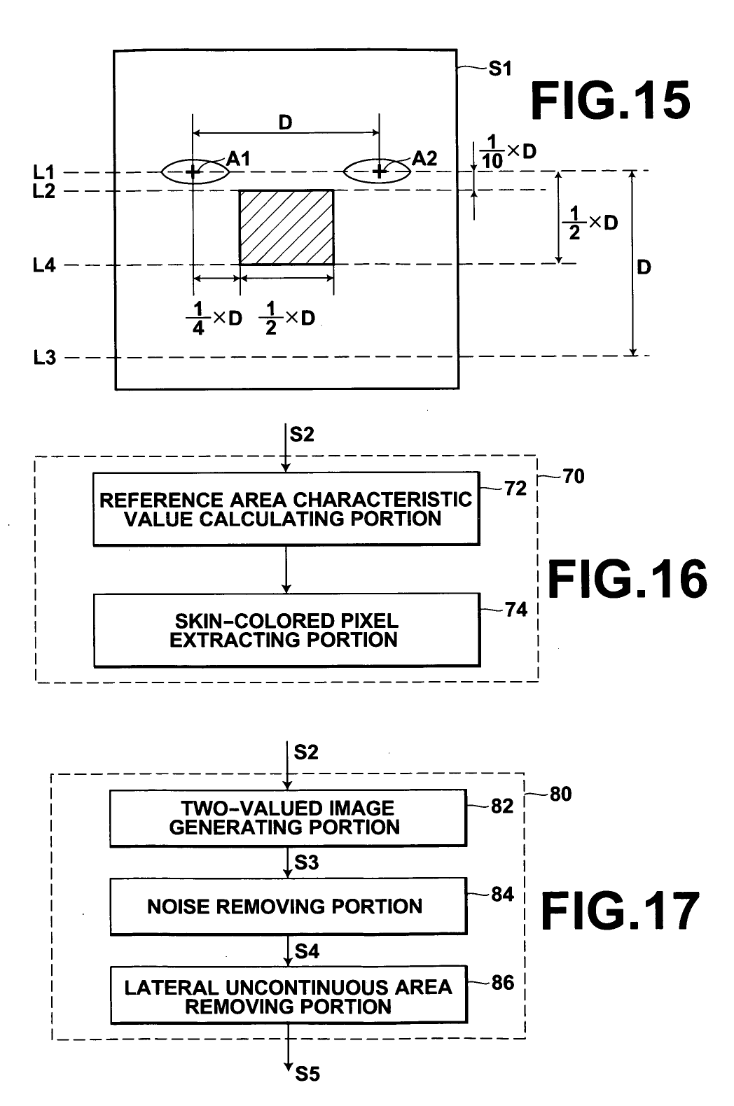

The reference area setting portion 60 sets as a reference area an area which is certainly of a skin-color in the face image S1, and in this particular embodiment, sets as the reference area an area from below the lower edge of the eyes (a position near the eyes) to above the tip of the nose (a position near the tip of the nose). Specifically, the reference area setting portion 60 first calculates the eye-to-eye distance D in the face image S1 from the positions of the eyes (points A1 and A2 shown in FIG. 15) obtained by the eye detecting portion 30. Though there are individual differences among persons in the distances between the parts of the human face, the distance between the eyes is substantially equal to the vertical distance from the line joining the eyes (broken line L1 in FIG. 15) to the mouth. On the basis of this fact, the vertical position of the mouth (broken line L3 in FIG. 15) is estimated. Finally, the middle between the eyes and the mouth is estimated as in a vertical position which is near the tip of the nose and above the tip of the nose (broken line L4 in FIG. 15) on the basis of the fact that the tip of the nose is in a vertical position toward the mouth between the mouth and the eyes.

The reference area setting portion 60 estimates the position D/10 downward remote from the center of the eyes (broken line L1 in FIG. 15) as a vertical position near the eye and lower than the lower edge of the eye.

The reference area setting portion 60 sets the reference area within the area between the lines L1 and L4 thus obtained. Since the line L1 is below the lower edge of the eye and the line L4 is above the tip of the nose, the eyelashes, pupils and the moustache are removed from the area between the lines L1 and L4. Accordingly, any part within this area may be considered to be of a skin-color. However, in this embodiment, in order to avoid the influence of the moustache on the outer side the cheeks, the part which has a width equal to the eye-to-eye distance D in the face image S1 and is laterally in the middle of the area between the lines L1 and L4 (the hatched portion in FIG. 15) is set as the reference area.

The reference area setting portion 60 outputs information representing the reference area thus set to the skin-colored area extracting portion 70.

The skin-colored area extracting portion 70 extracts a skin-colored area from a smoothened face image S2 and has a structure shown in FIG. 16. As shown in FIG. 16, the skin-colored area extracting portion 70 comprises a reference area characteristic value calculating portion 72 and a skin-colored pixel extracting portion 74.

The reference area characteristic value calculating portion 72 calculates a mean angle α of hue of the images in the reference area in the smoothened face image S2 as the characteristic value in the reference area.

The skin-colored pixel extracting portion 74 extracts all the pixels which are of a color approximate to the color of the reference area in the smoothened face image S2. For example, the skin-colored pixel extracting portion 74 extracts the pixels which meet all the following conditions.

1. R≧G≧K×B (R, G, B respectively represent the values of R, G and B, and K represents a coefficient which is in the range of 0.9 to 1.0 and 0.95 here)

2. The difference between its angle of hue and the mean angle α of hue of the reference area is smaller than a predetermined Hue-range threshold value (e.g., 20).

The skin-colored area extracting portion 70 takes the area formed by the pixels extracted by the skin-colored pixel extracting portion 74 as the skin-colored area and outputs information representing the position of the skin-colored area to the face area mask generating portion 80.

The face area mask generating portion 80 generates a face area mask image S5 from the smoothened face image S2 in order to facilitate detection of the lateral width of a face and FIG. 17 is a block diagram showing the structure thereof. As shown in FIG. 17, the face area mask generating portion 80 comprises a two-valued image generating portion 82, a noise removing portion 84 and a lateral uncontinuous area removing portion 86.

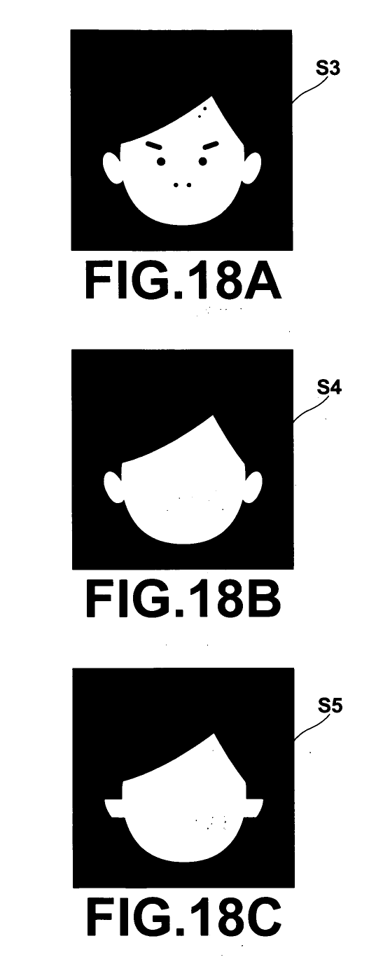

The two-valued image generating portion 82 carries out two-value transformation on the smoothened face image S2, where the pixels in the skin-colored area is transformed into white pixels (that is, the value of the pixels is transformed into, for instance, 255, a maximum value in the dynamic range) and the pixels in the area other than the skin-colored area is transformed into black pixels (that is, the value of the pixels is transformed into 0) on the basis of the information representing the position of the skin-colored area extracted by the skin-colored area extracting portion 70, and obtains a two-valued image S3 such as shown in FIG. 18A.

The noise removing portion 84 carries out removal of noise on the two-valued image S3 in order to facilitate detection of the lateral width of a face and obtains a noise-removed image S4. The noise to be removed by the noise removing portion 84 may include noise which can make it difficult to detect the lateral width of a face or can provide inaccurate result of detection as well as those in the usual sense. In the image processing system of this embodiment, the noise removing portion 84 carries out the removal of noise in the following manner.

1. Removal of an Isolated Small Area

An “isolated small area” as used here means an area which is surrounded by skin-colored areas and is isolated from other non-skin-colored areas and is smaller than a predetermined threshold value, and may be, for instance, an eye (pupil) or a nose hole in the face. Further, the black dot-like noise in the forehead in the example shown in FIG. 18A is an isolated area.

The noise removing portion 84 removes such an isolated area from the two-valued image S3 by transforming the pixels thereof into white pixels.

2. Removal of an Elongated Area

An “elongated area” as used here means a black laterally extending elongated area. The noise removing portion 84 carries out scanning on the two-valued image S3 with the main scanning direction and the sub-scanning direction respectively extending in the vertical direction and the lateral direction of the face to detect such an elongated area and removes the detected elongated area from the two-valued image S3 by transforming the pixels thereof into white pixels.

By this, a frame of glasses or hair hanging over the eyebrow or the face can be removed.

FIG. 18B shows an example of a noise-removed image S4 obtained by the noise removing portion 84.

The lateral uncontinuous area removing portion 86 carries out processing, where a skin-colored area which is uncontinuous in the lateral direction is removed, on the noise-removed image S4 obtained by the noise removing portion 84 and obtains the face area mask image S5. Specifically, the lateral uncontinuous area removing portion 86 carries out scanning on the noise-removed image S4 with the main scanning direction and the sub-scanning direction respectively extending in the vertical direction and the lateral direction of the face to detect an uncontinuous position where the skin-colored area (represented by white dots) is laterally uncontinuous and removes the skin-colored area on the right or left side of the detected position remoter from the center of the skin-colored area by transforming the pixels thereof into black pixels.

FIG. 18C shows the face area mask image S5 obtained by carrying out the processing, where a skin-colored area which is uncontinuous in the lateral direction is removed, on the noise-removed image S4 shown in FIG. 18B. As shown in FIG. 18C, the pixels representing the portion of the ear above the upper root and below the lower root are blackened in the face area mask image S5.

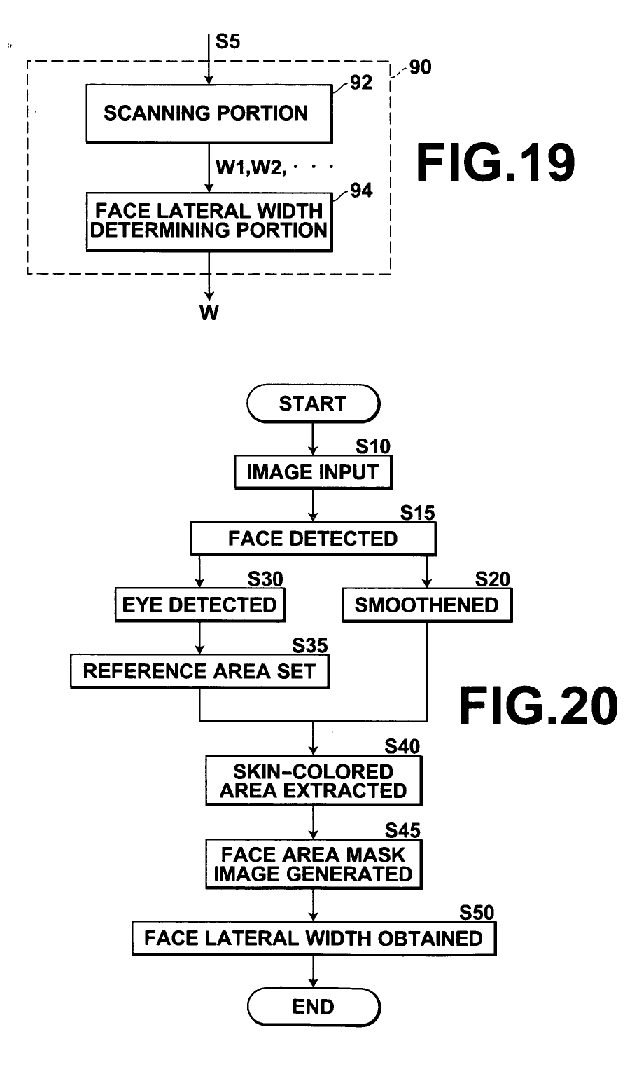

The face lateral width obtaining portion 90 obtains the lateral width W of the face by the use of the face area mask image S5, and FIG. 19 is a block diagram showing the structure thereof. As shown in FIG. 19, the face lateral width obtaining portion 90 comprises a scanning portion 92 and a face lateral width determining portion 94. The scanning portion 92 carries out scanning on the face area mask image S5 shown in FIG. 18C with the main scanning direction and the sub-scanning direction respectively extending in the vertical direction and the lateral direction of the face to detect lateral widths W1, W2 . . . of the white area for the respective sub-scanning positions (positions in the vertical direction of the face). The face lateral width determining portion 94 takes the sub-scanning position where the lateral width uncontinuously increases on the basis of change of the lateral widths W1, W2 . . . in the vertical direction (i.e., the position of the upper root of the ear in the vertical direction) as the first position, and detects the sub-scanning position which is nearer to the chin than the first position and remoter from the chin by one sub-scanning position than the position in which the lateral width uncontinuously decreases (i.e., the position of the lower root of the ear in the vertical direction) as the second position. Then the face lateral width determining portion 94 determines the largest lateral width in the range from the first position to the second position as the lateral width W of the face.

FIG. 20 is a flowchart showing the processing in the image processing system shown in FIG. 1. As shown in FIG. 20, the approximate position and size of the face are detected by the face detecting portion 20 from the images S0 input through the image input portion 10 (steps S10 and S15) and the positions of the eyes are detected by the eye detecting portion 30 from the face image S1 detected by the face detecting portion 20 (step S30). Then the reference area for extracting skin-colored area is set by the reference area setting portion 60 on the basis of the positions of the eyes (step S35). The face image S1 is smoothened by the smoothening portion 50 to obtain the smoothened image in parallel to the processing by the eye detecting portion 30 and the reference area setting portion 60. (step S20) The skin-colored area extracting portion 70 calculates a mean angle α of hue of the images in the reference area set by the reference area setting portion 60 and extracts pixels where the difference between its angle of hue and the mean angle α of hue of the reference area is smaller than a predetermined threshold value from the face image S1 as the skin-colored pixels to obtain a skin-colored area formed by the skin-colored pixels. (step S40) The face area mask generating portion 80 carries out processing such as removal of noise and removal of an uncontinuous area on the face image S1 and obtains the face area mask image S5. (step S45) The face lateral width obtaining portion 90 carries out scanning on the face area mask image S5 with the main scanning direction and the sub-scanning direction respectively extending in the vertical direction and the lateral direction of the face to detect lateral widths W1, W2 . . . of the white area for the respective sub-scanning positions and at the same time, takes the sub-scanning position where the lateral width uncontinuously increases on the basis of change of the lateral widths W1, W2 . . . in the vertical direction as the first position, and detects the sub-scanning position which is below the first position and above the position in which the lateral width uncontinuously decreases (i.e., the position of the lower root of the ear in the vertical direction) by one sub-scanning position as the second position. Then the face lateral width obtaining portion 90 determines the largest lateral width in the range from the first position to the second position as the lateral width W of the face. (step S50)

As can be understood from the description above, in the image processing system of this embodiment, on the basis of the fact that the lateral widths in the respective vertical positions in the range from the upper root of the ear to the lower root of the ear in a human face are larger than those of other parts, this range is detected and the largest lateral width in this range is obtained as the lateral width of the face. With this arrangement, the lateral width of the face can be surely and accurately obtained, and processing requiring the lateral width of the face such as trimming for a certification photograph the standard of which defines the lateral width of the face or for a graduation album where the size of the face must be unified is permitted.

Further, in the image processing system of this embodiment, since an area which is surely of a skin-color in the face in the photographic images of the face is set in the reference area and the area formed by pixels having a color approximate to the reference area is detected as the skin-colored area when a skin-colored area is detected in the face in the photographic images of the face, the skin-colored area can be certainly detected without being affected by the difference among the individuals, which leads to an accurate detection of the lateral width of the face.

Though, a preferred embodiment of the present invention has been described above, the image processing method and system and the computer program for the purpose need not be limited to the embodiment described above, but may be variously modified within the scope of the spirit of the present invention.

For example, the skin-colored area may be detected in a method other than by the skin-colored area extracting portion 70 in the embodiment described above. Specifically, pixels having a color included in a skin color range set on the basis of the values of pixels in the reference area in a two-dimensional plane having r and g respectively represented by r=R/(R+G+B) and g=G/(R+G+B) as the two coordinate axes, wherein R, G and B respectively represents the R value, G value and B value, may be detected as skin-colored pixels. The skin color range may be set, for instance, by obtaining average values of r and g in the reference area and setting as the skin color range a range where a predetermined range having average value of r as its center intersects with a predetermined range having average value of g as its center.

Further, the lateral width of the face may be determined as the larger of the lateral width in the position of the upper root of the ear and that in the position of the lower root of the ear.

Further, though, in the image processing system shown in FIG. 1, the position of the face or the eyes is automatically detected, they may be manually designated by the user.

Further, the reference area may be set in a manner other than that used in the image processing system shown in FIG. 1. For example, the area which is of a skin color may be designated by the user and the designated area may be set as the reference area.

1. An image processing method for detecting a lateral width of a face in a photograph of face comprising the steps of
detecting a skin-colored area in a face,
obtaining a lateral width of the detected skin-colored area in each of the positions along a direction from the vertex to the chin of the face, and
determining the lateral width in a predetermined position in a range from a first position to a second position as the lateral width of the face, the first position being a position in which the lateral width uncontinuously increases, and the second position being a position which is nearer to the chin than the first position and remoter from the chin by one position than the position in which the lateral width uncontinuously decreases.

2. An image processing method as defined in claim 1, in which the largest lateral width in the range from the first position to the second position is determined as the lateral width of the face.

3. An image processing method as defined in claim 1 in which the larger of the lateral width in the first position and that in the second position is determined as the lateral width of the face.

4. An image processing method as defined in claim 1 in which the skin-colored area in the face is detected as an area formed by pixels detected
by setting an area which is estimated to be of a skin-color in the face as a reference area, and
detecting pixels which are of a color approximating the color of the reference area from the face.

5. An image processing method as defined in claim 4 in which the reference area is an area between the eyes and the tip of the nose in the face.

6. An image processing system for detecting the lateral widths of faces in photographs of face comprising
a skin-colored area detecting means for detecting a skin-colored area in a face;
a width obtaining means for obtaining a lateral width of the detected skin-colored area in each of the positions along a direction from the vertex to the chin of the face, and
a face width determining means for determining the lateral width in a predetermined position in a range from a first position to a second position as the lateral width of the face, the first position being a position in which the lateral width uncontinuously increases, and the second position being a position which is nearer to the chin than the first position and remoter from the chin by one position than the position in which the lateral width uncontinuously decreases.

7. An image processing system as defined in claim 6 in which the face width determining means determines the largest lateral width in the range from the first position to the second position as the lateral width of the face.

8. An image processing system as defined in claim 6 in which the face width determining means determines the larger of the lateral width in the first position and that in the second position as the lateral width of the face.

9. An image processing system as defined in claim 6 in which the skin-colored area detecting means comprises
a reference area setting means which sets an area which is estimated to be of a skin-color in the face as a reference area, and
a skin-colored pixel detecting means which detects pixels which are of a color approximating the color of the reference area from the face and detects as the skin-colored area an area formed by the detected pixels.

10. An image processing system as defined in claim 6 in which the reference area setting means sets an area between the eyes and the tip of the nose in the face as the reference area.

11. A computer readable medium in which is recorded a computer program for causing a computer to execute an image processing comprising the steps of
detecting a skin-colored area in a face;
obtaining a lateral width of the detected skin-colored area in each of the positions along a direction from the vertex to the chin of the face, and
determining the lateral width in a predetermined position in a range from a first position to a second position as the lateral width of the face, the first position being a position in which the lateral width uncontinuously increases, and the second position being a position which is nearer to the chin than the first position and remoter from the chin by one position than the position in which the lateral width uncontinuously decreases.

12. A computer readable medium as defined in claim 11 in which the skin-colored area in the face is detected as an area formed by pixels detected
by setting an area which is estimated to be of a skin-color in the face as a reference area, and
detecting pixels which are of a color approximating the color of the reference area from the face.
